(19) United States
(12) Patent Application Publication
(10) Pub. No.: US 2025/0090989 A1
(43) Pub. Date: Mar. 20, 2025

(54) TRICKLE-BED SCRUBBER AND SCRUBBING PROCESS WITH WOODCHIP PACKED BED

(71) Applicant: NATIONAL RESEARCH COUNCIL OF CANADA, Ottawa (CA)

(72) Inventors: Samira LOTFI, Ottawa (CA); Weiguo MA, Kanata (CA); Kevin AUSTIN, Ottawa (CA); James BUTLER, Ottawa (CA)

(21) Appl. No.: 18/885,018

(22) Filed: Sep. 13, 2024

Related U.S. Application Data
(60) Provisional application No. 63/538,423, filed on Sep. 14, 2023.

(51) Int. Cl. B01D 47/06; B01D 47/14

(52) U.S. Cl. CPC B01D 47/06; B01D 47/14; B01D 2257/93

(57) ABSTRACT

A scrubbing medium, such as cooking oil, is trickle flowed through a packing material that includes woodchips. Gas, such as from a gasifier, is flowed through the packing material and the scrubbing medium to scrub the gas of tar and particulates. The gas may further flow through a polishing material, such as charcoal. The woodchips include a mixture of coarse and fine woodchips with at least about 25% fine woodchips. A flow of scrubbed gas with reduced tar and particulates in outputted.

### FIELD

The present disclosure relates to gas scrubbers, such as trickle-bed scrubbers.

### BACKGROUND

Scrubbers are often used in industrial and commercial settings to remove various materials, such as pollutants and particulates, from gases. A typical scrubber includes a bed of material through which gas is flowed to remove unwanted materials from the gas. Liquid, such as water, may be provided to the scrubber to facilitate removal of unwanted materials from the gas.

As there are various sources of gas that may carry unwanted materials, there are accordingly many types and designs of scrubber. However, many of these utilize bed materials which are expensive to purchase, maintain, or dispose of, such as stainless steel or ceramic beads, fine meshes, etc. These bed materials can require difficult cleaning using chemical or physical treatments that can be detrimental to the local environment, contaminate cleaning water, or run a risk for the people maintaining the gasifier.

### SUMMARY

According to an aspect of the present disclosure, a process includes trickle flowing a scrubbing medium through a packing material that includes woodchips and flowing a gas through the packing material and scrubbing medium to scrub the gas of tar and particulates. The woodchips include a mixture of coarse and fine woodchips with at least about 25% fine woodchips. The process further includes outputting a flow of scrubbed gas with reduced tar and particulates.

The process may further include receiving the gas as a flow of producer gas output from a gasifier.

The process may further include providing used packing material that includes the mixture of coarse and fine woodchips to the gasifier as fuel.

The process may further include providing used scrubbing medium to the gasifier as fuel.

The process may further include flowing the scrubbed gas through a polishing material to output a scrubbed and polished gas.

According to another aspect of the present disclosure, a scrubber apparatus includes a hollow body, a liquid inlet positioned at the hollow body, a liquid outlet positioned at the hollow body, a gas inlet positioned at the hollow body, a gas outlet positioned at the hollow body, and a packed-bed support positioned within the hollow body and configured to support a bed of packing material that includes a mixture of coarse and fine woodchips with at least about 25% fine woodchips. The liquid inlet and liquid outlet are arranged to provide a flow of scrubbing medium through the bed of packing material that includes the mixture of coarse and fine woodchips. The gas inlet and gas outlet are arranged to provide a flow of gas through the bed of packing material that includes the mixture of coarse and fine woodchips and the scrubbing medium therein.

The scrubber apparatus may further include a polishing-material support positioned downstream of the packed-bed support with respect to the flow of gas through the bed of packing material.

The polishing-material support is configured to hold a bed of charcoal, biochar, activated carbon, fibers, wood shreds, or a combination of such.

The scrubber apparatus may further include an applicator positioned between the polishing-material support and the packed-bed support, the applicator connected to the liquid inlet and configured to apply the scrubbing medium onto the bed of packing material that includes the mixture of coarse and fine woodchips.

The applicator may include a drip plate configured to drip the scrubbing medium onto the bed of packing material

The applicator may include a sprayer configured to spray the scrubbing medium onto the bed of packing material.

The scrubber apparatus may further include a scrubbing medium circulation loop configured to circulate the scrubbing medium from the liquid outlet to the liquid inlet.

The scrubbing medium circulation loop may include a pump and a filter configured to circulate and filter the scrubbing medium.

According to another aspect of the present disclosure, a scrubber with a packed bed and a scrubbing medium is used to scrub a producer gas of tar and particulates. The packed bed includes a mixture of coarse and fine woodchips with at least about 25% fine woodchips.

Further to the above aspects, the woodchips may be screened to less than about 55 mm.

Further to the above aspects, the fine woodchips may be screened to between 5 to 20 mm in width.

Further to the above aspects, the scrubbing medium may include oil, biodiesel, used cooking oil, or a combination of such.

Further to the above aspects, the scrubbing medium may include a triglyceride, a fatty acid, a fatty acid methyl ester (FAME), diesel fuel, or a combination of such.

Further to the above aspects, the polishing material may include charcoal, biochar, activated carbon, fibers, wood shreds, or a combination of such.

Further to the above aspects, the mixture of coarse and fine woodchips may be at least about 25% fine woodchips by volume.

### BRIEF DESCRIPTION OF THE FIGURES

FIG. 1 is a diagram of an example scrubber apparatus.

FIG. 2 is a diagram of an example system with the scrubber apparatus of FIG. 1.

FIG. 3A is a plan view of an example scrubbing medium applicator.

FIG. 3B is a plan view of another example scrubbing medium applicator.

FIG. 4A is a plot of experimental results showing tar hot-side and gravimetric cold-side concentration (left-axis) and removal efficiency (η, right-axis) using a scrubber consistent with the apparatus of FIG. 1 with various packed-bed and scrubbing media conditions.

FIG. 4B is a plot of experimental results showing particulate concentration at the hot side and cold side (left axis) and particulates removal efficiency (η, right axis) using a scrubber consistent with the apparatus of FIG. 1 with various packed-bed and scrubbing media conditions.

### DETAILED DESCRIPTION

Tar in gasifier producer gas is one of the main challenges for gasification for energy or fuel production. Tar condenses and polymerizes inside process piping downstream of the gasifier and may plug filters, form damaging deposits, and potentially corrode downstream equipment, such as generators and gas upgrading systems, reducing the lifespan of such equipment.

The environmental impact of known scrubbing systems is also a concern. Often gas clean-up systems use water as a clean-up medium, creating hazardous water that requires proper disposal. For small-scale applications, physical gas clean-up methods typically use cyclones, heat exchangers, tar condenser-scrubbers, water scrubbers, and packed bed filters.

There is a lack of simple, robust, and efficient technology to remove tar from producer gas in small-scale gasifier operations, such as small-scale gasification combined heat and power (CHP) systems that provide an alternative to diesel generators for power generation in remote communities and industrial sites.

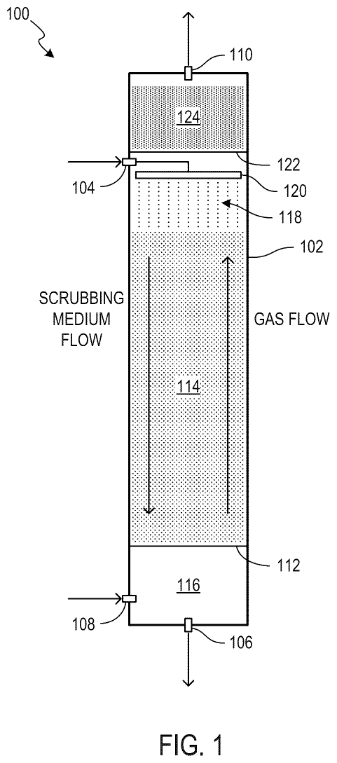

FIG. 1 shows an example scrubber apparatus 100. The scrubber apparatus 100 may be provided with a packed bed of coarse and fine woodchips, through which a liquid scrubbing medium, such as used cooking oil, is trickled. The scrubber apparatus 100 may be used to scrub tar and particulates from a gas provided by a gasifier. Scrubbed gas may be provided to an internal combustion engine, such as an electric generator. The use of woodchips and readily available fatty acids, oils, etc. make the scrubber apparatus 100 particularly useful for remote environments where more refined packing materials and scrubbing media may not be readily available.

The scrubber apparatus 100 has a hollow body 102. The hollow body 102 may be generally cylindrical with closed ends. The hollow body 102 may be section of pipe, a shell, a tank, a cannister, or a similar structure. The hollow body 102 is oriented vertically, as depicted, when in operation. In other examples, other shapes and orientation of hollow body may be used. The hollow body 102 may include a port, lid, or other openable structure to allow the removal and replacement of packing and polishing materials.

The scrubber apparatus 100 includes a liquid inlet 104 and a liquid outlet 106 positioned at the hollow body 102. The liquid inlet 104 and outlet 106 provide for flow of liquid into and out of the hollow body 102. The liquid inlet 104 and outlet 106 may include an opening, orifice, coupling, nozzle, flange, or other mechanical connection capable of communicating liquid.

The scrubber apparatus 100 includes a gas inlet 108 and a gas outlet 110 positioned at the hollow body 102. The gas inlet 108 and outlet 110 provide for flow of gas into and out of the hollow body 102. The gas inlet 108 and outlet 110 may include an opening, orifice, coupling, nozzle, flange, or other mechanical connection capable of communicating gas.

The scrubber apparatus 100 further includes a packed-bed support 112 positioned within the hollow body 102. In this example, the packed-bed support 112 is positioned towards the bottom end of the hollow body 102. The packed-bed support 112 is configured to support a bed of packing material (packed bed) 114 that includes a mixture of coarse and fine woodchips. The mixture has at least about 25% fine woodchips with the balance being coarse woodchips. The packed-bed support 112 may include a plate with holes, a grating, a mesh, a screen, a grid, a lattice, expanded metal, or similar structure with openings that allow the passage of liquid and gas and that impede the passage of the mixture of coarse and fine woodchips, so as to support the packed bed 114 and provide a volume 116 below the packed bed 114 for gravity drainage of liquid.

The packing material 114 is a mix of coarse and fine woodchips. The woodchips may be screened to less than about 55 mm, and the fine woodchips may be screened to between 5 to 20 mm in width. As mentioned above, fine woodchips are about 25% or more of the mixture. The remaining 75% or less is coarse woodchips. Increasing the proportion of fine woodchips may increase collection performance due to increase liquid to gas contact surface area, while possibly increasing pressure drop and risk of plugging. As such, the proportion of fine woodchips may be increased above 25% provided that such effects are considered or guarded against.

The liquid inlet 104 and outlet 106 are arranged with respect to packed-bed support 112 to provide for trickle flow of liquid scrubbing medium 118 through the bed of packing material 114. The liquid inlet 104 may be positioned above the packed-bed support 112 and above the highest expected or permitted level of packing material 114. A scrubbing-medium applicator 120, such as a sprayer or drip plate, may be provided inside the hollow body 102 and connected to the liquid inlet 104 to distribute (e.g., spray or drip) scrubbing medium 118 to the packed bed 114. The liquid outlet 106 may be positioned below the packed-bed support 112, such as at the lower volume 116, to extract scrubbing medium 118 after it passed through the packed bed 114 and packed-bed support 112. The flow of scrubbing medium 118 is driven by gravity and thus flows downwards through the packed bed 114.

Examples of suitable scrubbing media include oil, biodiesel, used cooking oil, a triglyceride, a fatty acid, a fatty acid methyl ester (FAME), diesel fuel, or a combination of such.

The gas inlet 108 and outlet 110 are arranged to provide a flow of gas to be scrubbed through the bed of packing material 114 with the scrubbing medium 118 trickle flowing under gravity therethrough. The gas inlet 108 may be positioned at the lower volume 116 to provide gas to the lower side of the packed-bed support 112. The gas outlet 110 may be positioned at an upper end of the hollow body 102 to permit scrubbed gas to flow out of the apparatus 100. Flow of gas is upwards through the packed bed 114.

The scrubber apparatus 100 may further include a polishing-material support 122 positioned above the packed bed 114. The polishing-material support 122 is downstream of the packed-bed support 112 with respect to the flow of gas through the packed bed 114 and thus receives flow of gas after the gas has passed through the packed bed 114. The polishing-material support 122 is above the scrubbing-medium applicator 120. The polishing-material support 122 is configured to hold a bed of polishing material 124 (char-bed), such as charcoal, biochar, activated carbon, fibers, wood shreds, or a combination of such. The polishing-material support 122 may include a plate with holes, a grating, a mesh, a screen, a grid, a lattice, expanded metal, or similar structure with openings that allow the passage of gas and that impede the passage of polishing material.

In operation, the scrubber apparatus 100 may be operated according to the following example process. The process is not limited to use with the scrubber apparatus 100 and may be used with other scrubber apparatuses.

A packing material 114 that includes a mixture of coarse and fine woodchips with at least about 25% fine woodchips as discussed herein, is loaded into the scrubber apparatus 100. A polishing material 124, such biochar (and/or other materials discussed herein), may be loaded into the scrubber apparatus 100 above the packing material 114, as well.

A scrubbing medium 118, such as used cooking oil (and/or other materials discussed herein), is trickle flowed through the packing material 114 via a liquid inlet and outlet 104, 106. The scrubbing medium 118 may be sprayed, dripped, or otherwise applied to the top of the packing material 114. At the same time, input gas, such producer gas outputted by a gasifier, is flowed upwards through the packing material 114 with scrubbing medium 118 trickling therethrough via gas inlet and outlet 108, 110. This scrubs the input gas of tar and particulates. Scrubbed gas may further flow upwards through the polishing material 124 to obtain scrubbed and polished gas. A flow of scrubbed, or scrubbed and polished, gas with reduced tar and particulates is outputted at the gas outlet 110.

The process may be performed continuously until the woodchip packing material 114 is saturated with tar/particulates. The used packing material 114 with scrubbing medium 118 contained therein may then be removed from the scrubber apparatus 100 and provided to the gasifier as fuel. Polishing material 124 when expended may also be provided to the gasifier 206 as fuel.

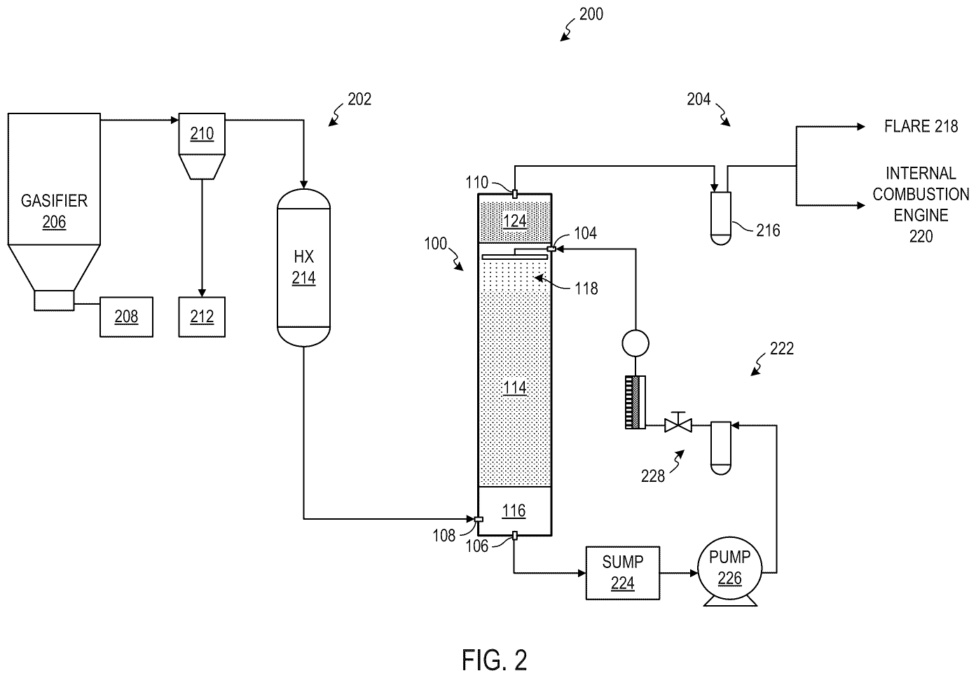

FIG. 2 shows an example system 200 that uses the scrubber apparatus 100. The system 200 may be a CHP system.

The system 200 includes upstream equipment 202, a scrubber apparatus 100, and downstream equipment 204. The scrubber apparatus 100 is positioned between the upstream equipment 202 and the downstream equipment 204 with respect to gas flow. That is, the upstream equipment 202 generates gas and the scrubber apparatus 100 scrubs and polishes the gas and provides scrubbed and polished gas to the downstream equipment 204.

The upstream equipment 202 may include a gasifier 206, such as a downdraft gasifier, as well as supporting equipment, such as an ash collector 208 and cyclone 210 connected to the gasifier 206. The ash collector 208 collects solid waste from the gasifier 206. The cyclone 210 separates particulates from the flow of producer gas generated by the gasifier 206, and such particulates may be removed from the system at a particulate collector 212 connected to the cyclone 210.

The upstream equipment 202 may additionally or alternatively include a heat exchanger 214 to take heat from the producer gas outputted by the gasifier 206 and transfer such heat another fluid, such as water or air to heat a building, structure, or vehicle.

Gas output from the upstream equipment 202, such as the output of the heat exchanger 214 or cyclone 210, is connected to the gas inlet 108 of the scrubber apparatus 100.

The downstream equipment 204 may include a water collector 216 and a flare 218 and/or internal combustion engine 220. The water collector 216 removes water from the scrubbed and polished gas. The flare 218 burns scrubbed and polished gas. The internal combustion engine 220 may drive an electric generator and thus generate electricity by combustion of the scrubbed and polished gas. The internal combustion engine 220 may drive another type of apparatus, such as a pump, vehicle, or machine. The flare 218 may be omitted if the internal combustion engine 220 is used. Alternatively, the flare 218 may be used to burn off a portion of the gas that is not useable in the internal combustion engine 220.

The gas outlet 110 of the scrubber apparatus 100 is connected to the gas input of the downstream equipment 204.

The system 200 further includes a scrubbing medium circulation loop 222 connected between the liquid inlet 104 and outlet 106 of the scrubber apparatus 100. The scrubbing medium circulation loop 222 circulates scrubbing medium, such as oil, etc., through the packing material 114 of the scrubber apparatus 100. The scrubbing medium circulation loop 222 may be a closed loop. The scrubbing medium 118 contained therein may be periodically removed and replaced as part of maintenance. The scrubbing medium 118 contained in the circulation loop 222 may be completely or partially replaced with fresh scrubbing medium. Removed scrubbing medium 118 may be mixed with feedstock and used as fuel for the gasifier 206.

In this example, scrubbing medium circulation loop 222 includes a sump 224, a pump 226, and a flow controller 228. The sump 224 is connected to the liquid outlet 106 of the scrubber apparatus 100 and collects scrubbing medium 118 that has completely trickled through the packing material 114. The pump 226 is connected to the sump 224 and pumps the scrubbing medium 118 through the loop 222. Without shutting down the apparatus 100, used scrubbing medium 118 may be removed from the sump 224 and fresh scrubbing medium 118 may be introduced to the sump 224. The flow controller 228 is connected between the pump 226 and the liquid inlet 104 of the scrubber apparatus 100. The flow controller 228 controls the flow of scrubbing medium 118 through the loop 222. The flow controller 228 includes a valve and may further include a filter, water collector, and other components.

In operation, the system 200 may be operated according to the following example process. The process is not limited to use with the system 200 and may be used with other systems.

Fuel, which may include used woodchip packing material 114, scrubbing medium 118, and polishing material 124, is loaded into the gasifier 206. The gasifier 206 is operated and generates heated producer gas, which bulk particulates removed by the cyclone 210 and particulate collector 212. The producer gas flows through the heat exchanger 214, which warms another fluid to heat a building, structure, or vehicle. Producer gas continues to the scrubber apparatus 100, which operates as discussed above, to scrub and polish the gas, while the scrubbing medium circulation loop 222 circulates scrubbing medium through the woodchip packing material 114. The scrubber apparatus 100 outputs scrubbed and polished gas to an internal combustion engine 220 and/or flare 218. The internal combustion engine 220 may drive a generator to generate electricity.

The process may be performed continuously until the woodchip packing material 114 is saturated with tar/particulates. The used packing material 114 with scrubbing medium 118 contained therein may then be removed from the scrubber apparatus 100 and provided to the gasifier 206 as fuel. Polishing material 124 when expended may also be provided to the gasifier 206 as fuel. Scrubbing medium 118 in the scrubbing medium circulation loop 222 may be drained and replaced from time to time, and used scrubbing medium 118 may also be provided to the gasifier 206 as fuel.

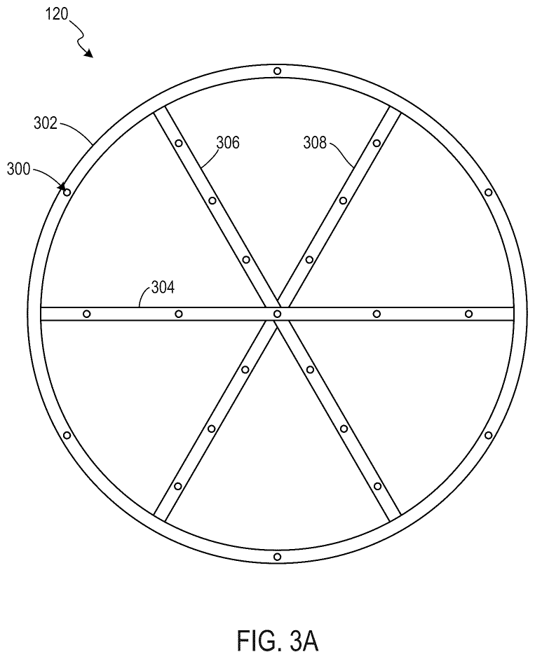

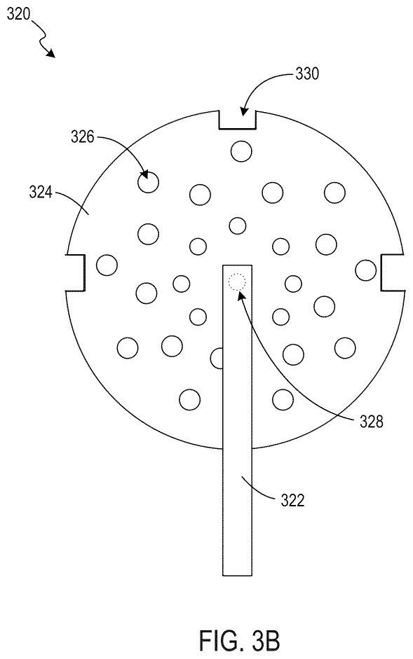

FIG. 3A shows an example applicator 120 to distribute scrubbing medium, such as oil, onto packing material, such as a mixture of coarse and fine woodchips. The applicator 120 includes a network of tubing in which holes 300 are provided to output scrubbing medium. In this example, a circular tube 302 joins with three cross-tubes 304, 306, 308. Tubes 304, 306, 308 may extend across the diameter of the circular tube 302 evenly, such as at about 60 degrees angular spacing. The circular tube 302 has a hole pitch that, in this example, provides for six approximately evenly spaced holes 300. Tube 304 connects to the circular tube 302 and crosses the apparent center of the circular tube 302. In this example, tube 304 includes five approximately evenly spaced holes 300. Each of the tubes 306, 308 connects to the circular tube 302 and crosses the apparent center of the circular tube 302. In this example, each of the tubes 306, 308 includes six holes 300 that are approximately evenly spaced when considered with the center hole 300 of the tube 304. The applicator 120 may serve as a sprayer for spraying the scrubbing medium onto the packing material or serve as a perforated drip plate to allow for the scrubbing material to be applied to the packing material. Based on the sizing of the holes 300 the sizing of the filter in the flow controller 228 may need to be adjusted to prevent passage of particulates which may block the holes 300.

FIG. 3B shows another example applicator 320 to distribute scrubbing medium, such as oil, onto packing material, such as a mixture of coarse and fine woodchips. The applicator 320 may be used in place of the applicator 120. The applicator 320 includes a fluid supply pipe 322 and a plate 324 through which openings, such as holes, 326 are provided. The plate 324 may further include openings 330, such as holes or notches, at its perimeter. The fluid supply pipe 322 extends over the plate 324 and terminates at an opening 328 that may be positioned above the center of the plate 324. Scrubbing medium provided to the pipe 322 flows out the opening 328, drops onto the plate 324 flowing over the plate 324, and drips through the openings 326, 330 onto the packing material. The openings 326, 330 of the plate 324 may be sized and positioned to provide for even dripping of scrubbing medium onto the packing material. The openings 330 at the perimeter of the plate 324 may prevent scrubbing medium from collecting against the inner wall of the hollow body that contains the plate 324. Other features, aspects, and details of the applicator 120 may apply to the applicator 320.

Experiments were conducted with an apparatus consistent with the scrubber apparatus 100 discussed above. Used-cooking oil was selected as the scrubbing medium. Pine woodchip packing material was used with 75% coarse pine woodchips and 25% fine pine woodchips. The scrubber was able to reduce the tar and particulates in the producer gas from gasification of pinewood (8% moisture) from 1.38 to 0.28 g/Nm³, and 0.209 to 0.082 g/Nm³, respectively. Components such as benzene, toluene, naphthalene, and biphenylene were determined to be the major tar components. After passing the scrubber, most tar was removed, with a preference for removal of multi-ringed aromatics and gravimetric tars. It was also determined that parameters such as tar and particulate concentration, feedstock moisture content, and feedstock source affect the performance of the gas clean-up system.

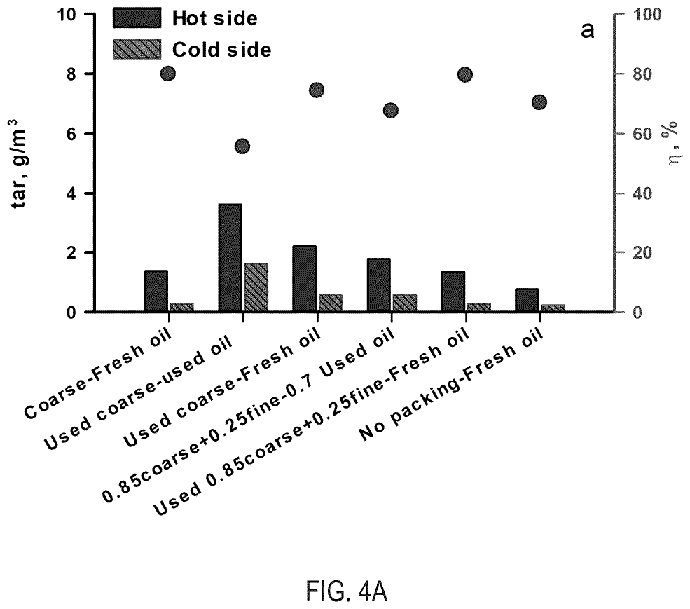

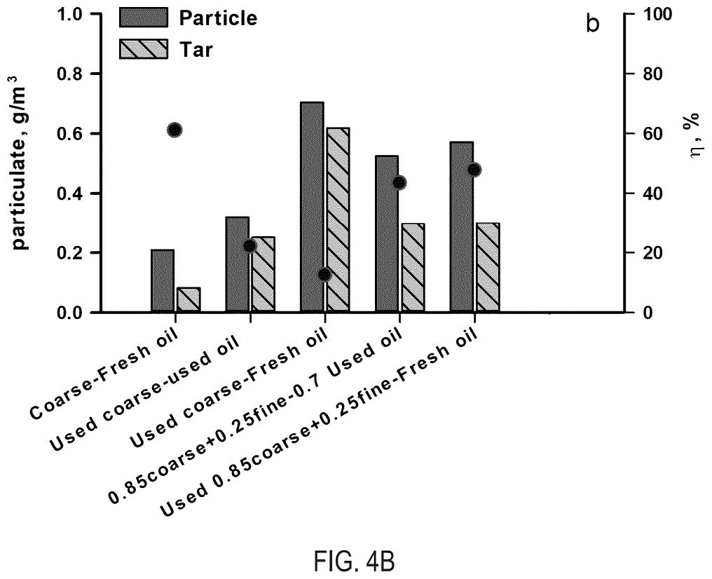

With regard to the experiments conducted, FIGS. 4A and 4B show gravimetric tar and particulate concentrations and their removal efficiencies before (hot side, i.e., gas inlet 108) and after (cold side, i.e., gas outlet 110) the scrubber for different bed pickings and age of oil. Replacing the packed-bed by trickle-bed when fresh waste cooking oil was used as the scrubber media and coarse particle filled the packed-bed provided a tar removal efficiency of 79%, even at low hot side tar concentration of 1.4 g/Nm³ (FIG. 4A, Coarse-Fresh oil). Oil circulation increases the tar removal efficiency by increasing liquid/gas contact. Tar removal efficiency of the trickle-bed reduced from 79% to 56% after the packing material and waste oil were run for 3.5 hours (FIG. 4A, Used coarse-Used oil). Replacing the used waste oil with fresh waste oil without changing the wood chips increased the tar removal efficiency to 74%. Tar removal efficiency was reduced when oil was used more than 3 hours. Partial replacement of the oil with fresh oil is expected to keep the removal efficiency optimal. This demonstrates the saturation level of the oil has a considerable effect on tar removal (FIG. 4A, Used coarse-Fresh oil).

The use of differently sized packing material, 75% coarse and 25% fine wood chips, and 30% used oil to 70% fresh one generated a tar removal efficiency of 67.5% when initial tar concentration was 1.78 g/Nm³ (FIG. 4A, 0.75 coarse+0.25 fine−0.7 Used oil). Replacing all the used oil with fresh oil with 75% coarse chips and 25% fine chips packing configuration produced a high tar removal efficiency of 79.5% (FIG. AA, 0.75 coarse+0.25 fine−Fresh oil). In this case, the packed-bed chips had already been used for 2 hours. This demonstrates that the oil has a large impact on the tar removal. The use of a mixture of coarse and fine chips gave the highest tar removal efficiency. About 25% fine chips were used to prevent excessive pressure drop and plugging inside the packed bed. Deeper beds and finer packing, such as with greater than 25% fine woodchips, are contemplated increase collection performance due to increase liquid to gas contact surface area. The tested trickle bed with 75% coarse and 25% fine woodchips had a lower pressure drop across the gas clean-up system than a comparable dry packed bed.

One test was conducted using the trickle bed with no packing material. FIG. 4A (No packing-Fresh oil) shows the contaminant concentrations and removal efficiencies from this test. Without packing and using fresh waste cooking oil, tar removal efficiency was 70% even given that this run had the lowest produced (hot side) tar concentration of 0.77 g/m³. This indicates that the oil is responsible for a large part of the tar removal in the trickle bed system and the woodchips act as packing material to increase gas/liquid surface area for gas contact with the oil. The addition of the wood chips packing material increased the tar removal efficiency to 79.5% through increased gas/liquid contact. Further, it is apparent that the scrubber is able to remove tar from the producer gas even at low tar concentration.

The high removal efficiency of the system reduces tar contamination of downstream equipment, increasing equipment lifespan and reducing operational cost.

The use of woodchips as packing material, particularly the proportions of coarse and fine woodchips discussed, provide high efficiency in removing tar and particulates and preventing residue formation. The woodchips do not cause significant pressure drop compared to filters or finer packed bed material.

The media used in the scrubber may be disposed of in the gasifier by being mixed in with fresh fuel once saturated. This increases the overall efficiency of the system and reduces or eliminates hazardous waste, which may result from the cleaning products used to clean traditional stainless steel or ceramic beds.

The media used in the scrubber are easily sourced. The woodchip packing may be the same woodchips used as the gasifier fuel. The fatty acid media may be cooking oil (fresh or used) or biodiesel. The polishing material may be barbeque charcoal or unburnt char from the gasifier itself. This reduces the complexity of the system and its operational cost.

As far as the scrubbing material is concerned, vegetable oils composed of diglycerides and triglycerides (fatty acids on a glycerol backbone) are useful solvents to remove tars owing to their characteristics of high absorption capacity for tar compounds, wide availability, low volatility, no health or storage hazards, and low cost. Used cooking oil containing a mixture of diglycerides and triglycerides and free fatty acids, is also an effective medium. FAME (fatty acid methyl ester, biodiesel) produced from vegetable oil is also an effective scrubbing medium. These types of solvents are plant-based and carbon neutral. Their volatility is low compared to chemical solvents or lubricating oil. In addition, such oils allow for tar removal at higher temperatures as compared to water and other solvents, reducing the cooling load needed prior to the trickle bed.

Minimal operator training or expertise is required to operate the system, as compared to systems that use chemical absorbents or high temperature catalysts for tar removal.

Moreover, the techniques described herein are particularly useful for remote communities and industrial sites that rely on diesel for power generation. Small scale biomass CHP may reduce dependency on fossil fuels and keep energy production within the community by using locally sourced biomass resources.

It should be recognized that features and aspects of the various examples provided above can be combined into further examples that also fall within the scope of the present disclosure. In addition, the figures are not to scale and may have size and shape exaggerated for illustrative purposes.

1. A process comprising:
trickle flowing a scrubbing medium through a packing material that includes woodchips;
flowing a gas through the packing material that includes woodchips and the scrubbing medium to scrub the gas of tar and particulates, wherein the woodchips include a mixture of coarse and fine woodchips with at least about 25% fine woodchips; and
outputting a flow of scrubbed gas with reduced tar and particulates.

2. The process of claim 1, further comprising receiving the gas as a flow of producer gas output from a gasifier.

3. The process of claim 2, further comprising providing used packing material that includes the mixture of coarse and fine woodchips to the gasifier as fuel.

4. The process of claim 2, further comprising providing used scrubbing medium to the gasifier as fuel.

5. The process of claim 1, wherein the woodchips are screened to less than about 55 mm.

6. The process of claim 1, wherein the fine woodchips are screened to between 5 to 20 mm in width.

7. The process of claim 1, wherein the scrubbing medium comprises oil, biodiesel, used cooking oil, or a combination of such.

8. The process of claim 1, wherein the scrubbing medium comprises a triglyceride, a fatty acid, a fatty acid methyl ester (FAME), diesel fuel, or a combination of such.

9. The process of claim 1, further comprising flowing the scrubbed gas through a polishing material to output a scrubbed and polished gas.

10. The process of claim 9, wherein the polishing material comprises charcoal, biochar, activated carbon, fibers, wood shreds, or a combination of such.

11. The process of claim 1, wherein the mixture of coarse and fine woodchips is at least about 25% fine woodchips by volume.

12. A scrubber apparatus comprising:
a hollow body;
a liquid inlet positioned at the hollow body;
a liquid outlet positioned at the hollow body
a gas inlet positioned at the hollow body;
a gas outlet positioned at the hollow body; and
a packed-bed support positioned within the hollow body and configured to support a bed of packing material that includes a mixture of coarse and fine woodchips with at least about 25% fine woodchips;
wherein the liquid inlet and liquid outlet are arranged to provide a flow of scrubbing medium through the bed of packing material that includes the mixture of coarse and fine woodchips; and
wherein the gas inlet and gas outlet are arranged to provide a flow of gas through the bed of packing material that includes the mixture of coarse and fine woodchips and the scrubbing medium therein.

13. The scrubber apparatus of claim 12, further comprising a polishing-material support positioned downstream of the packed-bed support with respect to the flow of gas through the bed of packing material.

14. The scrubber apparatus of claim 13, wherein the polishing-material support is configured to hold a bed of charcoal, biochar, activated carbon, fibers, wood shreds, or a combination of such.

15. The scrubber apparatus of claim 13, further comprising an applicator positioned between the polishing-material support and the packed-bed support, the applicator connected to the liquid inlet and configured to apply the scrubbing medium onto the bed of packing material that includes the mixture of coarse and fine woodchips.

16. The scrubber apparatus of claim 15, wherein the applicator includes a drip plate configured to drip the scrubbing medium onto the bed of packing material.

17. The scrubber apparatus of claim 15, wherein the applicator includes a sprayer configured to spray the scrubbing medium onto the bed of packing material.

18. The scrubber apparatus of claim 12, further comprising a scrubbing medium circulation loop configured to circulate the scrubbing medium from the liquid outlet to the liquid inlet.

19. The scrubber apparatus of claim 18, wherein the scrubbing medium circulation loop includes a pump and a filter configured to circulate and filter the scrubbing medium.

20. The scrubber apparatus of claim 12, wherein the scrubbing medium comprises oil, biodiesel, used cooking oil, or a combination of such.

21. The scrubber apparatus of claim 12, wherein the scrubbing medium comprises a triglyceride, a fatty acid, a fatty acid methyl ester (FAME), diesel fuel, or a combination of such.

22. Use of a packed bed with a scrubbing medium in a scrubber to scrub a producer gas of tar and particulates, wherein the packed bed includes a mixture of coarse and fine woodchips with at least about 25% fine woodchips.

23. The use of claim 22, wherein the woodchips are screened to less than about 55 mm.

24. The use of claim 22, wherein the fine woodchips are screened to between 5 to 20 mm in width.

25. The use of claim 22, wherein the scrubbing medium comprises oil, biodiesel, used cooking oil, or a combination of such.

26. The use of claim 22, wherein the scrubbing medium comprises a triglyceride, a fatty acid, a fatty acid methyl ester (FAME), diesel fuel, or a combination of such.

27. The use of claim 22, in combination with use of a polishing material to polish scrubbed producer gas, wherein the polishing material comprises charcoal, biochar, activated carbon, fibers, wood shreds, or a combination of such.
